(19) United States
(12) Patent Application Publication
(10) Pub. No.: US 2014/0084510 A1
(43) Pub. Date: Mar. 27, 2014

(54) MOLDING DIE AND MOLDING METHOD FOR RESIN MOLDED PRODUCT

(71) Applicant: Yazaki Corporation, Tokyo (JP)

(72) Inventor: Masaru SHIMIZU, Makinohara-shi (JP)

(73) Assignee: Yazaki Corporation, Tokyo (JP)

(21) Appl. No.: 14/039,666

(22) Filed: Sep. 27, 2013

Related U.S. Application Data
(63) Continuation of application No. PCT/JP2012/059434, filed on Mar. 30, 2012.

(30) Foreign Application Priority Data
Apr. 1, 2011 (JP) 2011-082099

(51) Int. Cl. B29C 45/14

(52) U.S. Cl. CPC B29C 45/14065
USPC 264/261; 425/500

(57) ABSTRACT

A molding die is provided with cavities for fixing, by insert molding, round shaped collars or oblong shaped collars formed of metal to inner faces of insertion holes which are respectively formed in a plurality of fixing parts of a box body. In each of the cavities which is provided with a cylindrical boss part on which the round shaped collar is mounted, there are provided a plurality of projections which do not interfere when the round shaped collar is inserted over the cylindrical boss part, but interferes when the oblong shaped collar is inserted over the cylindrical boss part, thereby to prevent the oblong shaped collar from being erroneously inserted over the cylindrical boss part.

### CROSS REFERENCE TO RELATED APPLICATIONS

This application is a continuation of PCT application No. PCT/JP2012/059434, which was filed on Mar. 30, 2012 based on Japanese Patent Application (No. 2011-082099) filed on Apr. 1, 2011, the contents of which are incorporated herein by reference.

### BACKGROUND OF THE INVENTION

1. Field of the Invention

The present invention relates to a molding die and a molding method for a resin molded product.

2. Description of the Related Art

In case where an electrical junction box is mounted on an object to be assembled such as a vehicle body panel, for example, a plurality of fixing parts having insertion holes are provided on a box body of the electrical junction box, and the electrical junction box is fixed to the object to be assembled by means of fastening bolts which have been inserted into the insertion holes (Reference should be made to PTL 1, for example).

FIG. 9 is a schematic view of a part of an electrical junction box of this type, as seen from a fixing part side. An electrical junction box 101 includes a box body 101 which is a resin molded product, and a plurality of fixing parts 103, 104 which are provided so as to project from this box body 110. These fixing parts 103, 104 are provided with insertion holes 131, 141 for fixing the electrical junction box 101 to the object to be assembled, by means of the fastening bolts (not shown) which have been inserted therein.

Moreover, for ensuring rigidity of the insertion holes 131, 141, tubular bodies 133, 143 formed of metal (hereinafter, referred to as “collars”) are arranged on respective inner faces of the insertion holes 131, 141, to be integrally molded with the box body 110.

By the way, there are two types of the insertion holes 131, 141 which are appropriately formed in the fixing parts 103, 104 of the box body 110. One is a positioning hole in a round shape for positioning the box body 110 when it is mounted on the object to be assembled, and the other is a backrush absorbing hole in an oblong shape for absorbing dimensional errors of the box body 110 and the object to be assembled. Accordingly, there are also two types of collars to be arranged on the inner faces of these insertion holes 131, 141, namely, a cylindrical collar and an oblong cylindrical collar. On occasion of molding the box body 110, insert molding is carried out, by arranging the round shaped collar 133 or the oblong shaped collar 143 to a predetermined position in a molding die.

FIGS. 10 and 11 are sectional views of a part of a molding die 151 for molding the aforesaid box body 110, corresponding to a section taken along a line X-X in FIG. 9.

The molding die 151 is a die for injection molding, and includes a lower mold 152 and an upper mold 153. In order to fix the round shaped collar 133 to the fixing part 103 by insert molding, as a first step, in an open state of the mold as shown in FIG. 10, the round shaped collar 133 is fitted to a boss part 161 of the lower mold 152 for molding the round shaped insertion hole 131. The boss part 161 is formed in a columnar shape having an outer diameter substantially equal to an inner diameter of the round shaped collar 133.

Then, as shown in FIG. 11, molten resin is injected into a cavity space 156 which is formed between a cavity 154 of the lower mold 152 and a cavity 155 of the upper mold 153 which have been closed, from a gate which is not shown. In this manner, it is possible to integrally mold the box body 110 formed of synthetic resin in which the round shaped collar 133 is fixed to the fixing part 103 by insert molding. It is to be noted that the oblong shaped collar 143 is also fixed to the fixing part 104 by insert molding, in the same manner.

### CITATION LIST

### Patent Literature

[PTL 1] JP-A-2010-233357

### SUMMARY OF THE INVENTION

However, there has been a possibility, in the above described molding die 151, in that erroneous arrangement of the collar may occur. Specifically, when the round shaped collar 133 or the oblong shaped collar 143 corresponding to the boss part 161 is arranged at the predetermined position in the lower mold 152 (on the boss part 161 or so), the oblong shaped collar 143 happens to be mounted on the boss part 161, as shown in FIG. 12. When the lower mold 152 and the upper mold 153 are closed in a state where the oblong shaped collar 143 is mounted on the boss part 161, there is such possibility that a portion A of the upper mold 153 in FIG. 12 may be broken with a collision against an upper end of the oblong shaped collar 143.

Under the circumstances, in order to prevent the erroneous arrangement of the collar, such countermeasures as confirming the arrangement by visual observation, finally in a production process, or disposing the round shaped collar 133 and the oblong shaped collar 143 as far as possible from each other, without arranging them on a same plane in the product have been taken. However, they are not perfect countermeasures.

Therefore, in order to completely prevent the erroneous arrangement of the collar, it has been only way to set the inner diameter of the round shaped collar 133 to be larger than the inner diameter of the oblong shaped collar 143, so that the oblong shaped collar 143 cannot be mounted on the boss part 161 in a columnar shape. However, there is possibility in that in case where the round shaped collar 133 and the oblong shaped collar 143 have different inner diameters, it is necessary to prepare the fastening bolts to be inserted into the insertion holes having different diameters, which incurs an increase of cost.

The present invention has been made in view of the above described circumstances. It is an object of the present invention to provide a favorable molding die and molding method for a resin molded product in which cylindrical bodies or oblong cylindrical bodies formed of metal can be accurately arranged in a plurality of fixing parts.

In order to achieve the above described object, the molding die for a resin molded product according to the present invention has such characteristics as described below in (1) to (4).

(1) A molding die for a resin molded product having a plurality of fixing parts in which insertion holes are respectively formed, the molding die being provided with cavities for fixing a cylindrical body or an oblong cylindrical body formed of metal to inner faces of the insertion holes, by insert molding, wherein in each of the cavities which is provided with a cylindrical boss part on which the cylindrical body is to be mounted, there is provided an erroneous insertion preventing part which does not interfere when the cylindrical body is inserted over the cylindrical boss part, and which interferes when the oblong cylindrical body is inserted over the cylindrical boss part so as to prevent the oblong cylindrical body from being erroneously inserted over the cylindrical boss part.

(2) In the molding die for a resin molded product having the structure as described above in (1), the erroneous insertion preventing part includes a plurality of projections which are provided in parallel around the cylindrical boss part.

(3) In the molding die for a resin molded product having the structure as described above in (1), the erroneous insertion preventing part includes an annular projection which is provided concentrically with the cylindrical boss part, and has a lower height than the cylindrical boss part.

(4) A molding method for a resin molded product in which the resin molded product is molded, using the molding die for a resin molded product having the structure as described above in any one of (1) to (3).

According to the molding die for a resin molded product having the structure as described above in (1), in case where the oblong cylindrical body happens to be inserted over the cylindrical boss part by mistake, the erroneous insertion preventing part which is provided in the cavity interferes with the oblong cylindrical body, and prevents the oblong cylindrical body from being inserted over the cylindrical boss part. Therefore, it is possible to completely prevent the erroneous arrangement of the oblong cylindrical body.

According to the molding die for a resin molded product having the structure as described above in (2), because the erroneous insertion preventing part includes a plurality of the projections which are provided in parallel around the cylindrical boss part, marks (openings) of the erroneous insertion preventing part which remain on the resin molded product can be made small and less prominent. Therefore, appearances and mechanical strength of the product in vicinity of the insertion hole will not be remarkably deteriorated.

According to the molding die for a resin molded product having the structure as described above in (3), because the erroneous insertion preventing part includes the annular projection which is provided concentrically with the cylindrical boss part and has the lower height than the cylindrical boss part, mechanical strength of the erroneous insertion preventing part which is provided in the cavity can be easily secured, and the mold for the cavity can be easily formed.

According to the molding method for a resin molded product having the structure as described above in (4), it is possible to easily mold the favorable resin molded product in which the cylindrical bodies or the oblong cylindrical bodies are accurately arranged in a plurality of the fixing parts.

According to the present invention, it is possible to provide the favorable molding die and molding method for a resin molded product in which the cylindrical bodies or the oblong cylindrical bodies formed of metal can be accurately arranged in a plurality of the fixing parts.

The present invention has been heretofore briefly described. Details of the present invention will be further clarified, by reading through “Mode for Carrying Out the present invention” (hereinafter referred to as “an embodiment”) which will be described below, referring to the attached drawings.

### BRIEF DESCRIPTION OF THE DRAWINGS

FIG. 1 is a schematic view of a part of an electrical junction box which is molded by a molding die for a resin molded product in an embodiment according to the present invention, as seen from a fixing part side.

FIG. 2 is an enlarged view of the fixing part as shown in FIG. 1.

FIG. 3 is an enlarged view of the fixing part as shown in FIG. 1.

FIG. 4 is a sectional view of a part of the molding die for explaining a method of insert molding a cylindrical body in the fixing part as shown in FIG. 3, corresponding to a section taken along a line IV-IV in FIG. 3.

FIG. 5 is an enlarged perspective view of an essential part of a cavity as shown in FIG. 4.

FIG. 6 is a sectional view of a part of the molding die for explaining a state where an oblong cylindrical body is being inserted over a cylindrical boss part as shown in FIG. 4.

FIG. 7 is an enlarged perspective view of an essential part of the cavity as shown in FIG. 6.

FIGS. 8A, 8B, 8C and 8D are plan views respectively showing modifications of an erroneous insertion preventing part as shown in FIG. 4.

FIG. 9 is a schematic view of a part of a conventional electrical junction box, as seen from a fixing part side.

FIG. 10 is a sectional view of a part of a molding die for explaining a method of fixing a cylindrical body to the fixing part as shown in FIG. 9, by insert molding, corresponding to a section taken along a line X-X in FIG. 9.

FIG. 11 is a sectional view of a part of the molding die as shown in FIG. 10, in a closed state.

FIG. 12 is a sectional view of a part of the molding die for explaining a state where an oblong cylindrical body is inserted over a cylindrical boss part as shown in FIG. 10.

### DETAILED DESCRIPTION OF THE EXEMPLARY EMBODIMENTS

Now, a molding die and a molding method for a resin molded product in an embodiment according to the present invention will be described in detail, referring to the attached drawings.

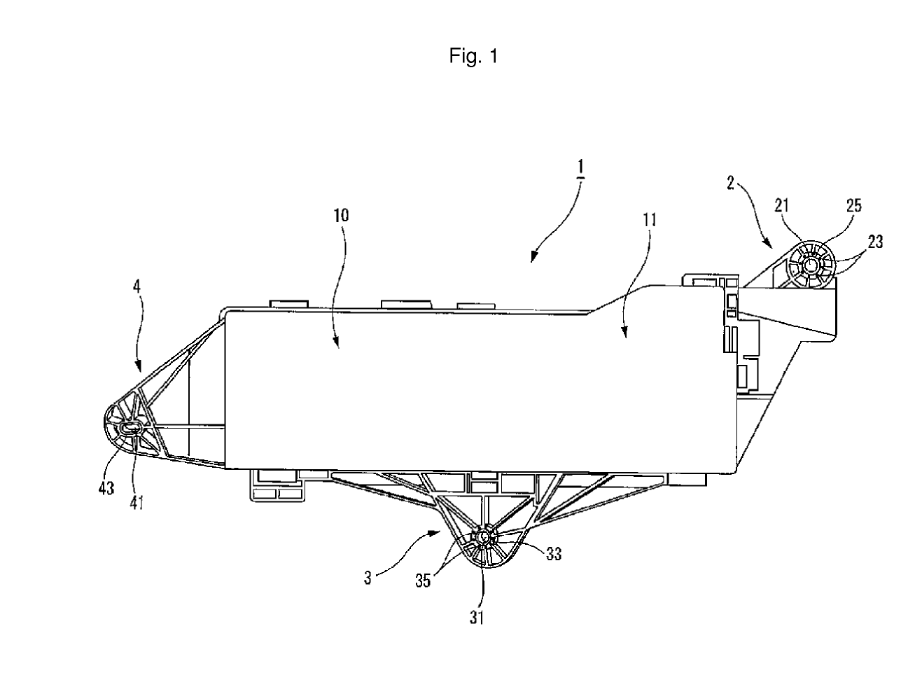

As shown in FIG. 1, an electrical junction box 1 which is molded by a molding die for a resin molded product in the embodiment includes a boxy body 10 which is the resin molded product, and a plurality of first to third fixing parts 2, 3, 4 which are provided so as to project from this box body 10.

The box body 10 includes a lower case 11 formed of synthetic resin, an upper case (not shown) formed of synthetic resin to be engaged with this lower case 11, and an electrical function part (for example, a composite including circuit boards electronic components, etc., although not shown) which is contained in an inner space formed between the lower case 11 and the upper case 11. Basically, the box body 10 has the same structure as the known box body, and its detailed description will be omitted.

The first to third fixing parts 2, 3, 4 are provided at predetermined positions of an outer edge of the lower case 11 so as to project outward. These first to third fixing parts 2, 3, 4 respectively have their faces corresponding to fixing faces of an object to be assembled such as a vehicle body panel, and are adapted to fix the electrical junction box 1 to the vehicle body panel by means of fastening bolts (not shown) which are inserted into insertion holes 21, 31, 41.

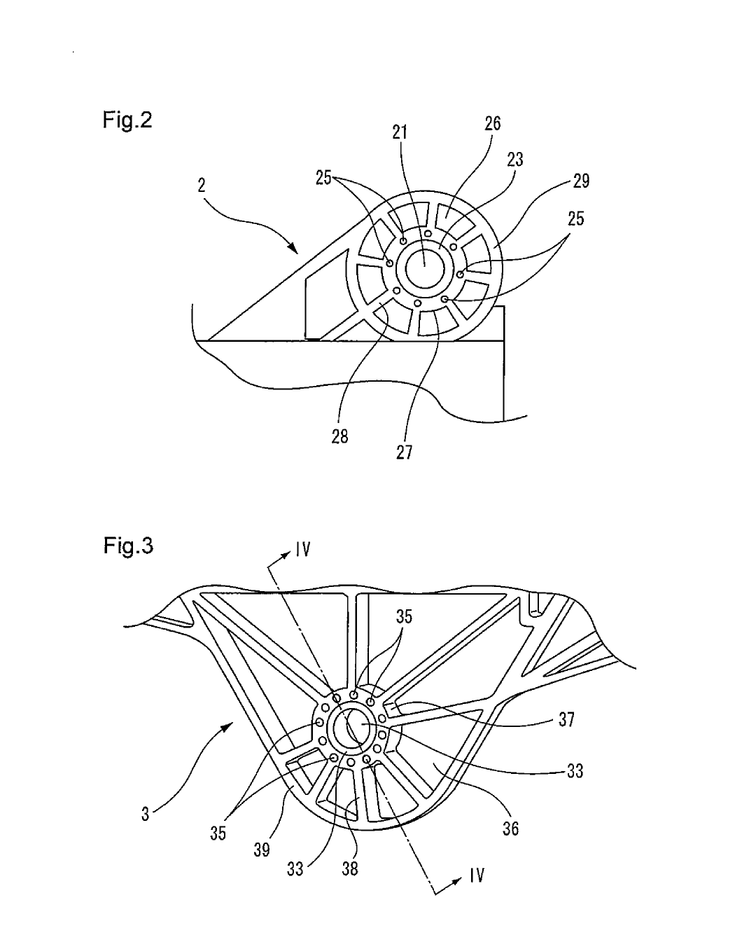

As shown in FIG. 2, the first fixing part 2 has a flat wall part 26 which is provided with a seat for a nut which is not shown, the insertion hole 21 which is formed so as to pass through the wall part 26, a round shaped collar 23 which is a cylindrical body formed of metal and arranged on an inner face of an annular rib 27 defining this insertion hole 21, a plurality of radial ribs 28 radially extending from an outer face of the annular rib 27, and an outer edge rib 29 positioned outside of the radial ribs 28.

The insertion hole 21 which is formed in the first fixing part 2 is a positioning hole in a round shape for positioning when the box body 10 is mounted on the vehicle body panel. The insertion hole 21 is so formed as to pass through having a larger diameter (substantially, an inner diameter of the round shaped collar 23) than a diameter of the fastening bolt which is not shown.

As shown in FIG. 3, the second fixing part 3 has a flat wall part 36 which is provided with a seat for a nut which is not shown, the insertion hole 31 which is formed so as to pass through the wall part 36, a round shaped collar 33 which is a cylindrical body formed of metal and arranged on an inner face of an annular rib 37 defining this insertion hole 31, a plurality of radial ribs 38 radially extending from an outer face of the annular rib 37, and an outer edge rib 39 positioned outside of the radial ribs 38.

The insertion hole 31 which is formed in the second fixing part 3 is a positioning hole in a round shape for positioning when the box body 10 is mounted on the vehicle body panel. The insertion hole 31 is so formed as to pass through having a larger diameter (substantially, an inner diameter of the round shaped collar 33) than a diameter of the fastening bolt which is not shown.

Further, the third fixing part 4 has substantially the same structure as the first and second fixing parts 2, 3. However, the insertion hole 41 which is formed in the third fixing part 4 is a backlash absorbing hole in an oblong shape for absorbing dimensional errors of the box body 10 and the vehicle body panel, and an oblong shaped collar 43 which is an oblong cylindrical body formed of metal is arranged on an inner face of the insertion hole 41. An opening width of this oblong shaped collar 43 at a shorter side is larger than the diameter of the fastening bolt which is not shown.

Further, a plurality of openings 25, 35 are respectively formed in the annular ribs 27, 37 of the first and second fixing parts 2, 3, around the insertion holes 21, 31 and in parallel with the insertion holes 21, 31. These openings 25, 35 are marks of the erroneous insertion preventing parts remaining in the box body 10 which has been integrally molded by a molding die 51 in this embodiment, which will be described below. The openings 25, 35 are through holes having a circular cross section. Such through holes as the openings 25, 35 are not formed in the third fixing part 4.

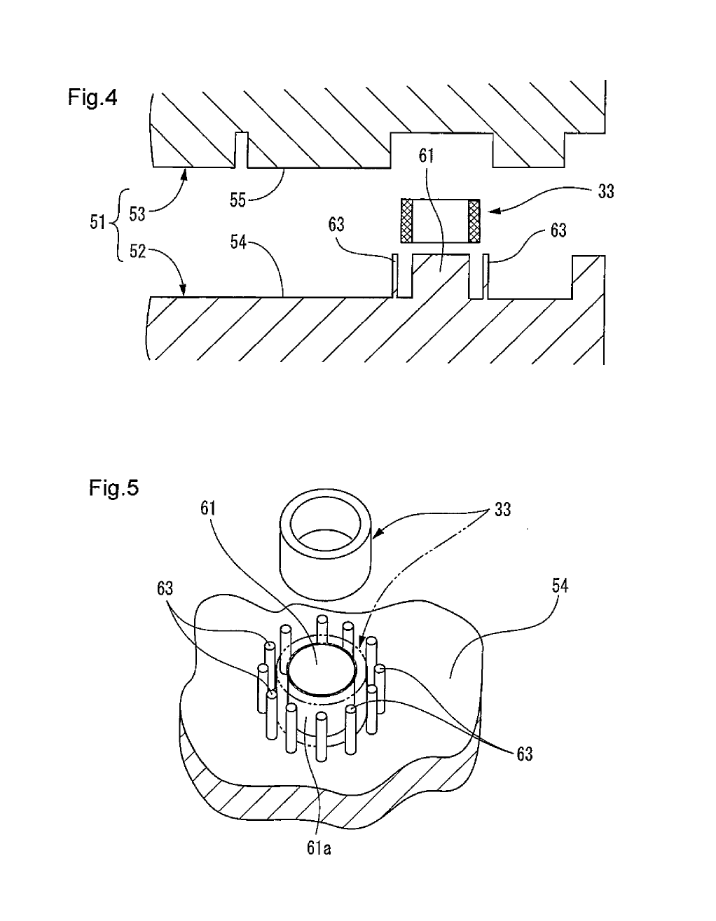

Then, the molding die 51 and the molding method for molding the box body 10 in the above described embodiment will be described referring to FIGS. 4 to 7.

The molding die 51 in this embodiment is an injection molding die provided with a lower mold 52 and an upper mold 53. By injecting molten resin into a cavity space formed on a mating plane between cavities 54, 55 of the lower mold 52 and the upper mold 53 which have been closed, from a gate which is not shown, it is possible to integrally mold the box body 10 formed of synthetic resin in which the round shaped collars 23, 33, and the oblong shaped collar 43 are fixed by insert molding.

As shown in FIGS. 4 and 5, in the cavity 54 of the lower mold 52 provided with a cylindrical boss part 61 on which the round shaped collar 33 is mounted, there is provided the erroneous insertion preventing part including a plurality of projections 63 which are provided in parallel with each other around the cylindrical boss part 61.

These projections 63 form a row of projections which are projected in an annular shape along an outer peripheral face 61a of the cylindrical boss part 61, keeping a predetermined distance larger than a wall thickness of the round shaped collar 33 with respect to the outer peripheral face 61a of the cylindrical boss part 61. Each of the projections 63 is formed in a columnar shape and has substantially the same height as the cylindrical boss part 61.

Because the projections 63 have substantially the same height as the cylindrical boss part 61, the openings 35 which are formed in the second fixing part 3 of the box body 10 are formed as through holes. However, it is possible to form the openings 35 as bottomed holes, by making the height of the projection 63 lower than the cylindrical boss part 61. Moreover, a plurality of the projections 63 need not necessarily be arranged in an annular shape, but may be arranged in an elongated annular shape or in a polygonal annular shape, provided that they are in a row of the projections which are projected in an annular shape along the outer peripheral face 61a of the cylindrical boss part 61.

Then, in an open state of the mold, as shown in FIG. 4, the round shaped collar 33 is fitted to the cylindrical boss part 61 of the lower mold 52 for molding the round shaped insertion hole 31 in the second fixing part 3. The cylindrical boss part 61 is formed in a columnar shape having an outer diameter substantially equal to an inner diameter of the round shaped collar 33.

When the round shaped collar 33 is inserted over the cylindrical boss part 61, a plurality of the projections 63, as the erroneous insertion preventing part, do not interfere with the round shaped collar 33, and therefore, it is possible to fit the round shaped collar 33 to the cylindrical boss part 61.

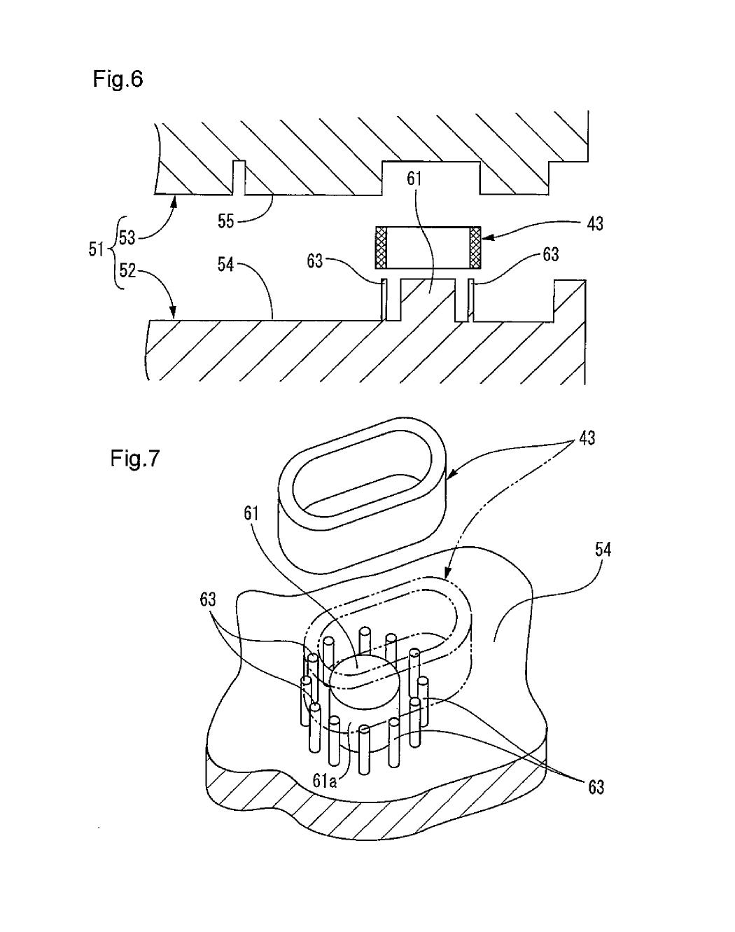

On the other hand, in an open state of the mold as shown in FIGS. 6 and 7, in case where the oblong shaped collar 43 is inserted over the cylindrical boss part 61 of the lower mold 52, by mistake, tip ends of the projections 63 of the erroneous insertion preventing part which is formed in the cavity 54 of the lower mold 52 come into contact with a lower end of the oblong shaped collar 43, and prevent the oblong shaped collar 43 from being inserted over the cylindrical boss part 61.

By appropriately setting the outer diameter and the number of the projections 63, and an interval between them, according to a wall thickness, an outer shape, and a shape of an opening of the oblong shaped collar 43, the projections 63 interfere with the oblong shaped collar 43, irrespective of an insertion direction, and prevent the oblong shaped collar 43 from being inserted over the cylindrical boss part 61.

Moreover, the erroneous insertion preventing part including a plurality of the projections 63 which are projected in parallel with each other around the cylindrical boss part 61 is also formed in the cavity 54 of the lower mold 52 for molding the round shaped insertion hole 21 in the first fixing part 2, and has the same function and effects. As the results, it is possible to completely prevent erroneous arrangement of the oblong shaped collar 43.

Therefore, according to the molding die 51, and the molding method using the molding die 51, it is possible to accurately arrange the round shaped collar 33 and the oblong shaped collar 43 respectively in the first to third fixing parts 2, 3, 4. As the results, it is possible to integrally mold the favorable box body 10 in which the round shaped collar 33 and the oblong shaped collar 43 are respectively provided in the first to third fixing parts 2, 3, 4 by insert molding.

Moreover, in the first and second fixing parts 2, 3 of the box body 10 which has been integrally molded by the molding die 51, there remain the openings 25, 35 which are the marks of the above described projections 63. However, appearances and mechanical strength of the box body 10 in vicinity of the insertion holes 21, 31 will not be remarkably deteriorated, because these openings 25, 35 are smaller in diameter and less prominent than the through holes 21, 31.

It is needless to say that structures of the fixing parts, insertion holes, cylindrical bodies, oblong cylindrical bodies, cavities, cylindrical boss parts, and erroneous insertion preventing parts etc. according to the molding die and molding method for a resin molded product of the present invention are not limited to the structures in the above described embodiment, but various modifications can be made on the basis of the gist of the present invention.

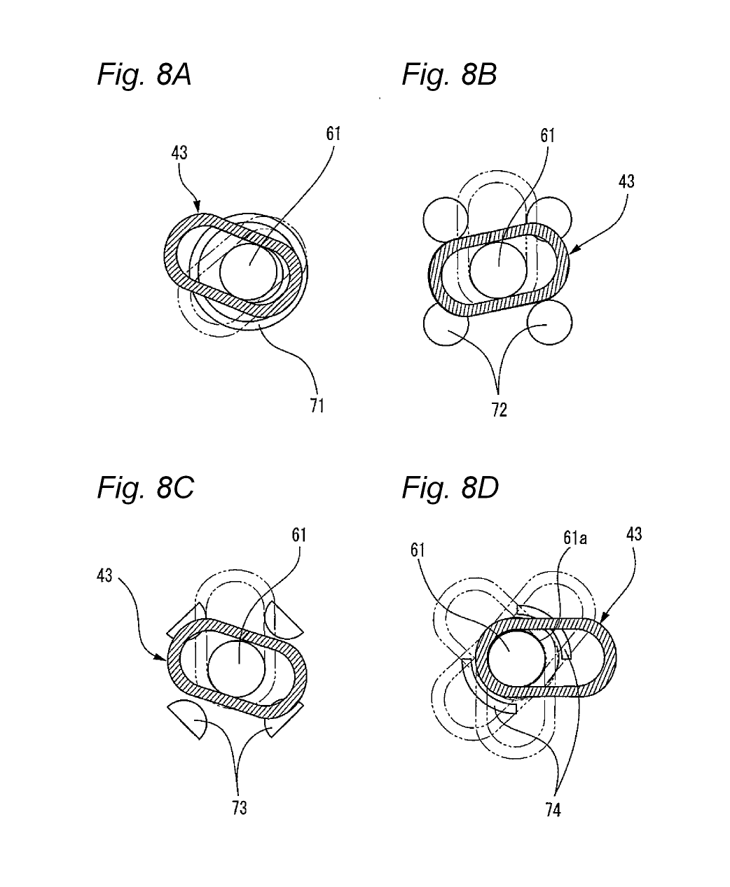

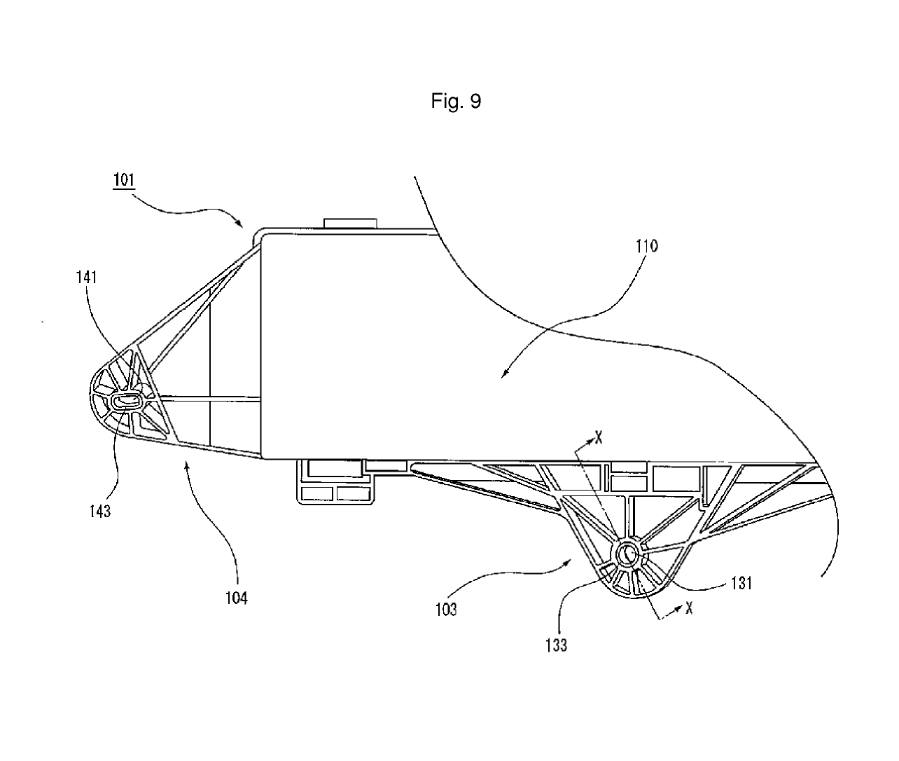

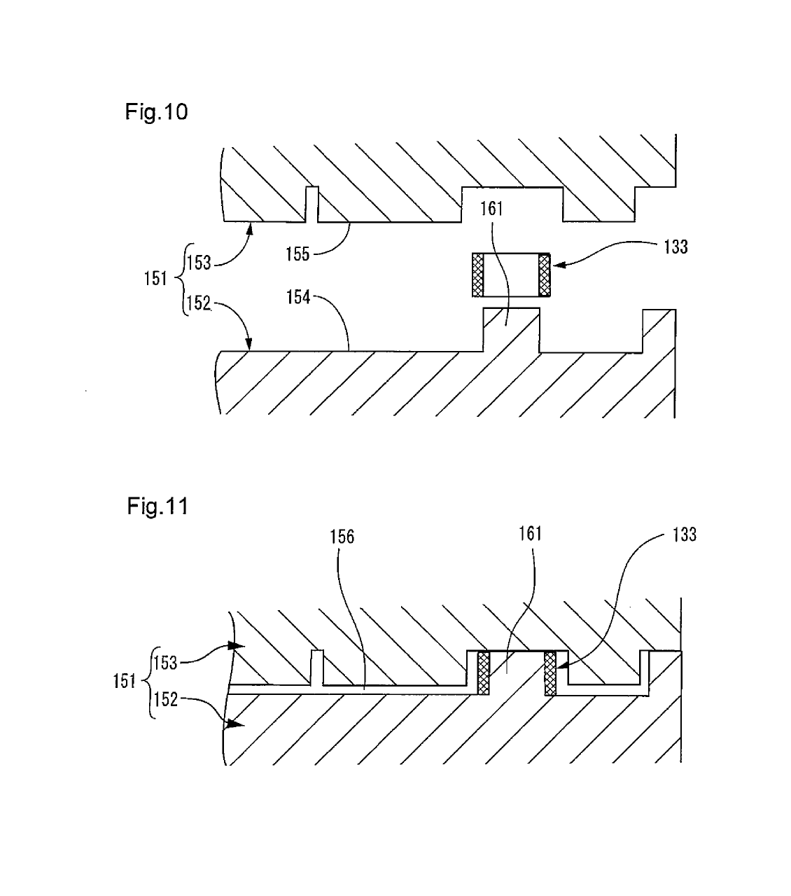

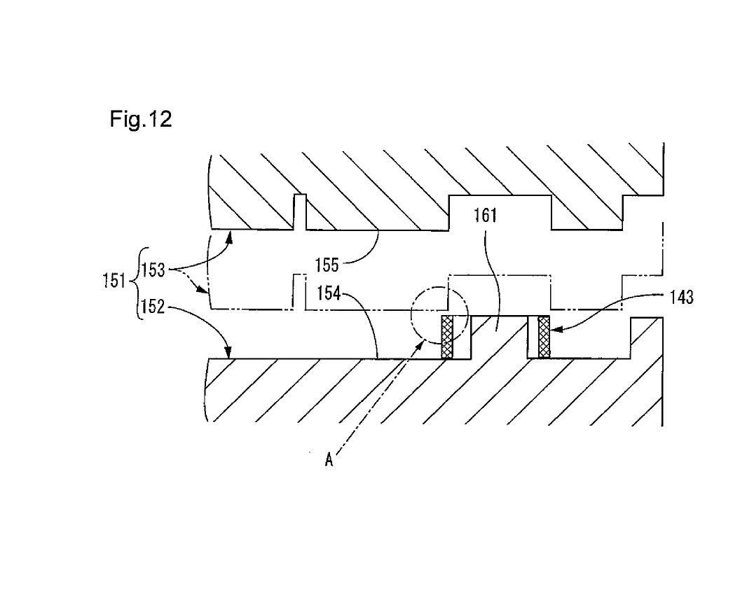

As shown in FIGS. 8A, 8B, 8C and 8D, various types of the erroneous insertion preventing part can be adopted, provided that the erroneous insertion preventing part interferes with the oblong cylindrical body, when the oblong cylindrical body is inserted over the cylindrical boss part, and can prevent the oblong cylindrical body from being erroneously inserted over the cylindrical boss part.

The erroneous insertion preventing part as shown in FIG. 8A includes an annular projection 71 which is provided concentrically with the cylindrical boss part 61, and has a lower height than the cylindrical boss part 61. According to this annular projection 71, mechanical strength of the erroneous insertion preventing part which is projected into the cavity 54 can be easily secured, and the mold for the cavity 54 can be easily formed.

The erroneous insertion preventing part as shown in FIG. 8B includes four projections 72 in a columnar shape which are provided in parallel with each other around the cylindrical boss part 61. By forming the projections 72 in a columnar shape having a larger diameter than the above described projections 63, it is possible to decrease the number of the projections to be provided. At the same time, the mechanical strength can be easily secured, and the mold for the cavity 54 can be easily formed. A cross sectional shape of the projections 72 is not limited to a round shape, but projections 73 having a semicircular cross sectional shape, as shown in FIG. 8C, may be also adopted. Besides, various cross sectional shapes such as an oblong shape, a polygonal shape can be also adopted.

The erroneous insertion preventing part as shown in FIG. 8D includes two projecting walls 74 in an arc shape which are provided along the outer peripheral face 61 a of the cylindrical boss part 61. By adopting the projecting walls 74, it is possible to further decrease the number of the projections, and the mechanical strength can be easily secured.

According to the present invention, it is possible to provide the favorable molding die and molding method for a resin molded product in which the cylindrical bodies or the oblong cylindrical bodies formed of metal can be accurately arranged in a plurality of the fixing parts.

What is claimed is:

1. A molding die for a resin molded product having a plurality of fixing parts in which insertion holes are respectively formed, the molding die being provided with cavities for fixing a cylindrical body or an oblong cylindrical body formed of metal to inner faces of the insertion holes, by insert molding,
wherein in each of the cavities which is provided with a cylindrical boss part on which the cylindrical body is to be mounted,
there is provided an erroneous insertion preventing part which does not interfere when the cylindrical body is inserted over the cylindrical boss part, and which interferes when the oblong cylindrical body is inserted over the cylindrical boss part so as to prevent the oblong cylindrical body from being erroneously inserted over the cylindrical boss part.

2. The molding die for a resin molded product as claimed in claim 1, wherein the erroneous insertion preventing part includes a plurality of projections which are provided in parallel with each other around the cylindrical boss part.

3. The molding die for a resin molded product as claimed in claim 1, wherein the erroneous insertion preventing part includes an annular projection which is provided concentrically with the cylindrical boss part, and has a lower height than the cylindrical boss part.

4. A molding method for a resin molded product in which the resin molded product is molded, using the molding die for a resin molded product as claimed in claim 1.
